(19) United States
(12) Patent Application Publication
(10) Pub. No.: US 2026/0126321 A1
(43) Pub. Date: May 7, 2026

(54) DETECTION DEVICE

(71) Applicant: Magnolia White Corporation, Tokyo (JP)

(72) Inventor: Shinya ASAKURA, Tokyo (JP)

(21) Appl. No.: 19/424,954

(22) Filed: Dec. 18, 2025

Related U.S. Application Data
(63) Continuation of application No. PCT/JP2024/018365, filed on May 17, 2024.

(30) Foreign Application Priority Data
Jun. 20, 2023 (JP) 2023-101112

(51) Int. Cl. G01J 1/02; G01J 1/04; G01J 1/08

(52) U.S. Cl. CPC G01J 1/0271; G01J 1/0488; G01J 1/08

(57) ABSTRACT

According to an aspect, a detection device includes: a light source device including point light sources; a light-transmitting placement substrate on which an object to be detected is placed; an optical filter that is located so as to overlap one side in the first direction of the placement substrate and has divided areas divided in a second direction; an optical sensor that is located so as to overlap one side in the first direction of the optical filter and includes photodetection elements arranged in a planar configuration. A first point light source of the point light sources overlaps a first divided area of the divided areas of the optical filter as viewed from the first direction. A first emitted light waveband of emitted light emitted from the first point light source overlaps a first transmitted light waveband of transmitted light transmitted through the first divided area.

### CROSS-REFERENCE TO RELATED APPLICATION

This application claims the benefit of priority from Japanese Patent Application No. 2023-101112 filed on Jun. 20, 2023 and International Patent Application No. PCT/JP2024/018365 filed on May 17, 2024, the entire contents of which are incorporated herein by reference.

### BACKGROUND

### 1. Technical Field

What is disclosed herein relates to a detection device.

### 2. Description of the Related Art

Japanese Patent Application Laid-open Publication No. 2018-033430 (JP-A-2018-033430) discloses a biosensor that includes an optical sensor including a photosensor (photodetection element), a culture vessel placed on the upper side of an imaging surface of the photosensor, and a point light source disposed above the culture vessel. In the biosensor of JP-A-2018-033430, light emitted from the point light source passes through a culture medium and a plurality of objects to be detected (microorganisms) in the culture vessel, and enters the photosensor.

In such a detection device, when a plurality of the point light sources are arranged, one object to be detected is irradiated with the light from the point light sources in respective different directions, potentially resulting in blurring of an image captured by the optical sensor.

For the foregoing reasons, there is a need for a detection device capable of improving accuracy of detection.

### SUMMARY

According to an aspect, a detection device includes: a light source device including a plurality of point light sources arranged in a planar configuration; a light-transmitting placement substrate that is located so as to overlap one side in a first direction of the light source device, and on which an object to be detected is placed; an optical filter that is located so as to overlap one side in the first direction of the placement substrate and has a plurality of divided areas divided in a second direction intersecting the first direction; an optical sensor that is located so as to overlap one side in the first direction of the optical filter and includes a plurality of photodetection elements arranged in a planar configuration. A first point light source of the point light sources overlaps a first divided area of the divided areas of the optical filter as viewed from the first direction. A first emitted light waveband of emitted light emitted from the first point light source overlaps a first transmitted light waveband of transmitted light transmitted through the first divided area.

### BRIEF DESCRIPTION OF THE DRAWINGS

FIG. 1 is a perspective view schematically illustrating a detection device according to a first embodiment of the present disclosure;

FIG. 2 is a perspective view illustrating a state in which a top panel has been removed from FIG. 1;

FIG. 3 is a schematic view of the detection device according to the first embodiment;

FIG. 4 is a block diagram illustrating a configuration example of the detection device;

FIG. 5 is a schematic view illustrating projection areas of emitted light from point light sources;

FIG. 6 is a schematic view of the detection device according to the first embodiment;

FIG. 7 is a schematic plan view of a light source device according to the first embodiment;

FIG. 8 is a schematic plan view of an optical filter according to the first embodiment;

FIG. 9 is a schematic diagram illustrating wavebands of the emitted light and transmitted light;

FIG. 10 is a schematic view illustrating a detection device according to a second embodiment of the present disclosure;

FIG. 11 is a schematic plan view of the optical filter according to the second embodiment; and

FIG. 12 is a schematic plan view of the light source device according to the second embodiment.

### DETAILED DESCRIPTION

The following describes modes (embodiments) for carrying out the present disclosure in detail with reference to the drawings. The present disclosure is not limited to the description of the embodiments given below. Components described below include those that are easily conceivable by those skilled in the art or those that are substantially identical thereto. In addition, the components described below can be combined as appropriate. What is disclosed herein is merely an example, and the present disclosure naturally encompasses appropriate modifications easily conceivable by those skilled in the art while maintaining the gist of the present disclosure.

To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present disclosure and the drawings, and detailed description thereof may not be repeated where appropriate.

In XYZ coordinates in the drawings, a Z direction (first direction) corresponds to the up-down direction; an X direction (second direction) corresponds to the left-right direction; and a Y direction (second direction) corresponds to the front-rear direction. The X direction intersects (at right angles) the Y and Z directions; the Y direction intersects (at right angles) the X and Z directions; and the Z direction intersects (at right angles) the X and Y directions. A Z1 side is one side in the first direction, and a Z2 side is the other side in the first direction. In the present embodiment, the first direction is the Z direction, and the second direction is a direction that intersects the first direction. That is, the second direction is not limited to the X or Y direction, but also includes directions between the X and Y directions.

### First Embodiment

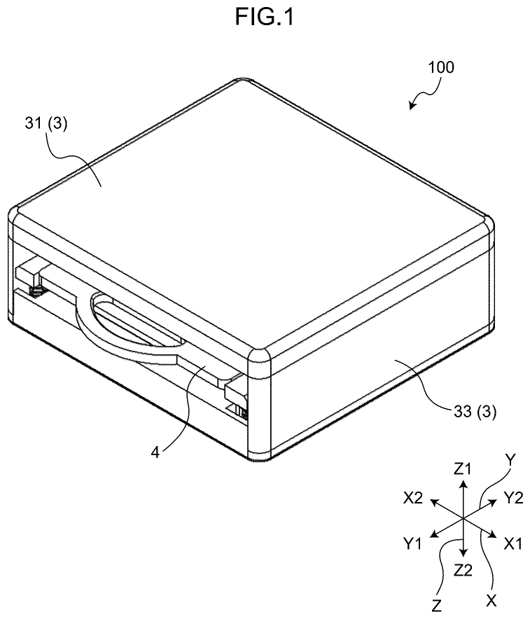

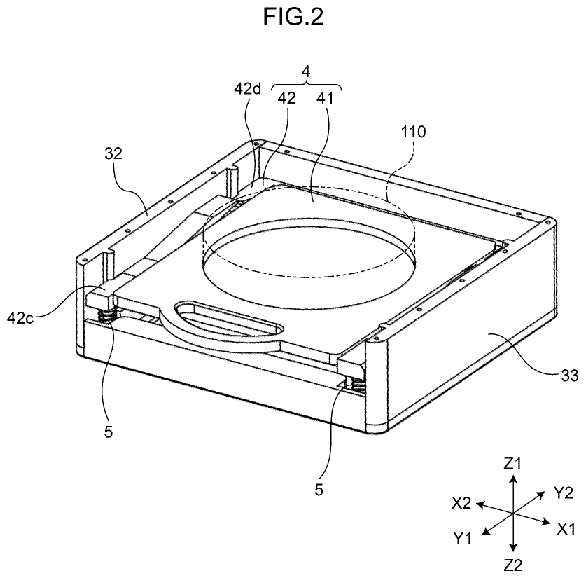

First, a first embodiment of the present disclosure will be described. FIG. 1 is a perspective view schematically illustrating a detection device according to the first embodiment. FIG. 2 is a perspective view illustrating a state in which a top panel has been removed from FIG. 1.

As illustrated in FIGS. 1 and 2, a detection device 100 has a substantially box shape. The detection device 100 includes a housing 3 and a holding member 4. The housing 3 includes a top panel 31 and side panels 32 and 33. The holding member 4 includes a plate 41 and a base plate 42. A container 110 is placed on the plate 41. Four corners of the base plate 42 are provided with a front holder 42c and a rear holder 42d. The front and rear holders 42c and 42d are urged upward (toward the Z1 side) by springs 5. Since the container 110 is placed on the plate 41, the plate 41 and the container 110 are urged upward (toward the Z1 side) by the springs 5.

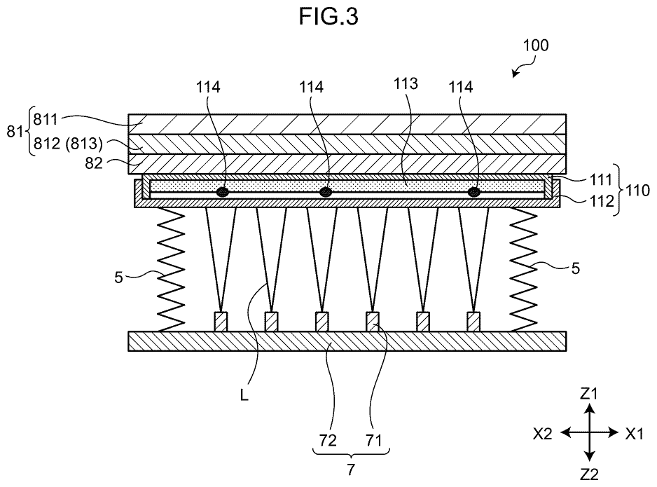

FIG. 3 is a schematic view of the detection device according to the first embodiment. As illustrated in FIG. 3, the detection device 100 includes a light source device 7, the container 110, an optical filter 82, an optical sensor 81, and the springs 5.

The light source device 7 includes a light source board 72 and a plurality of point light sources (light-emitting elements) 71. The point light sources 71 are light-emitting diodes (LEDs), for example. Thus, the light source device 7 includes the point light sources 71 arranged in a planar configuration.

The container 110 includes a placement substrate 111 and a cover member 112. The container 110 is a Petri dish, for example. The container 110 has a light-transmitting property. The placement substrate 111 is a light-transmitting substrate that is placed on the Z1 side of the light source device 7 so as to overlap the light source device 7, and on which an object to be detected 114 is placed.

In the present embodiment, the container 110 is placed upside down with respect to a normal container. That is, in the normal container, the placement substrate is located on the lower side and the cover member is located on the upper side. In contrast, in the container 110 according to the present embodiment, the placement substrate 111 is located on the upper side, while the cover member 112 is located on the lower side. In addition, the optical sensor 81 and the optical filter 82 are provided on the upper side (Z1 side) of the upside-down container 110, while the light source device 7 is provided on the lower side (Z2 side) of the upside-down container 110. A culture medium 113 (e.g., agar) is provided on the lower side of the placement substrate 111, and the object to be detected 114 is applied onto the culture medium 113 (surface on the lower side of the culture medium 113). The object to be detected 114 is, for example, microorganisms such as bacteria, or a sample containing the microorganisms, and forms colonies over time on the culture medium 113. The object to be detected 114 is not limited to the bacteria and may be other micro-objects such as cells.

The optical sensor 81 includes an array substrate 811 and a sensor pixel 812 (photodiode 813, or photodetection element). The optical sensor 81 is located on the Z1 side with respect to the optical filter 82 so as to overlap the optical filter 82. A plurality of the sensor pixels 812 are provided on a surface on the Z2 side of the array substrate 811. The optical filter 82 is an optical element that transmits, toward the photodiodes 813, components of light L emitted from the point light sources 71 that travel in a direction orthogonal to the optical sensor 81. The optical filter 82 is also called collimating apertures or a collimator.

The light L emitted from the point light sources 71 passes through the cover member 112, the culture medium 113, the placement substrate 111, and the optical filter 82, and is emitted toward the optical sensor 81. The intensity of light received by the photodiodes 813 (photodetection elements) of the optical sensor 81 differs between an area overlapping the object to be detected 114 and an area not overlapping the object to be detected 114. As a result, the optical sensor 81 can image the objects to be detected 114. Thus, the detection device 100 is a device for monitoring changes in the object to be detected 114 by placing the object to be detected 114 contained in the container 110, between the light source device 7 and the optical sensor 81, and imaging the object to be detected 114 using the optical sensor 81.

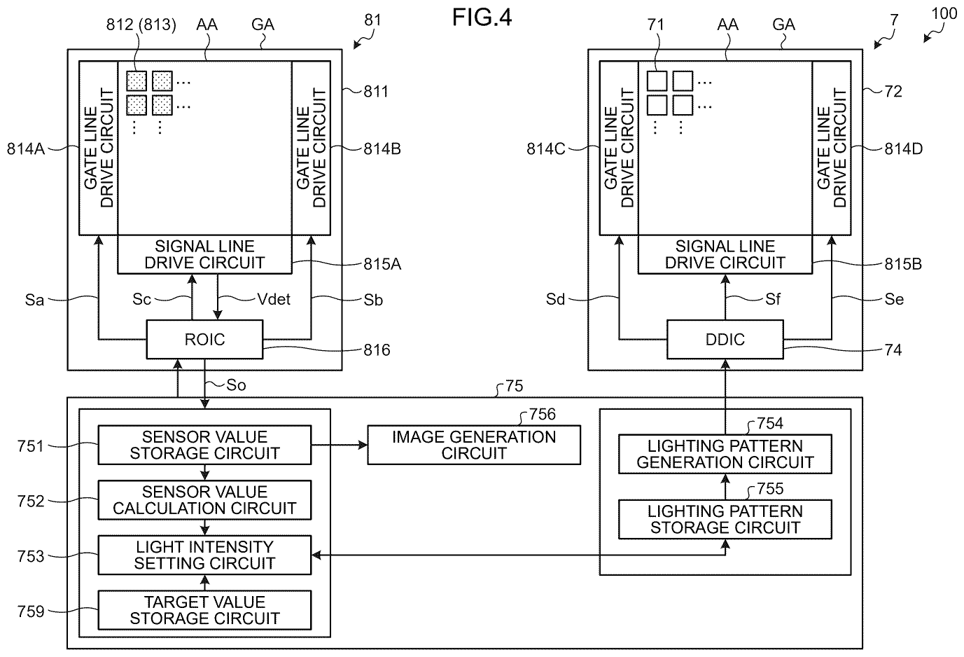

FIG. 4 is a block diagram illustrating a configuration example of the detection device. As illustrated in FIG. 4, the detection device 100 includes a host integrated circuit (IC) 75 that controls the optical sensor 81 and the light source device 7. The optical sensor 81 includes the array substrate 811, the sensor pixels 812 (photodiodes 813) formed on the array substrate 811, gate line drive circuits 814A and 814B, a signal line drive circuit 815A, and a detection control circuit (ROIC) 816.

The array substrate 811 is formed using a substrate 21 as a base. Each of the sensor pixels 812 is configured with the photodiode 813, a plurality of transistors, and various types of wiring.

The array substrate 811 has a detection area AA and a peripheral area GA. The detection area AA is an area provided with the sensor pixels 812 (photodiodes 813). The peripheral area GA is an area between the outer perimeter of the detection area AA and the outer edges of the array substrate 811, and is an area not provided with the sensor pixels 812. The gate line drive circuits 814A and 814B, the signal line drive circuit 815A, and the detection control circuit 816 are provided in the peripheral area GA.

Each of the sensor pixels 812 is an optical sensor that includes the photodiode 813 as a sensor element. Each of the photodiodes 813 outputs an electrical signal corresponding to light emitted thereto.

The detection control circuit 816 is a circuit that supplies control signals Sa, Sb, and Sc to the gate line drive circuits 814A and 814B and the signal line drive circuit 815A, respectively, to control operations of these circuits. The detection control circuit 816 includes a signal processing circuit that processes a detection signal Vdet from each of the photodiodes 813.

The detection control circuit 816 processes the detection signals Vdet from the photodiodes 813, and outputs sensor values So based on the detection signals Vdet to the host IC 75. Through this operation, the detection device 100 detects information on the object to be detected 114.

The light source device 7 includes the light source board 72, the point light sources 71 formed on the light source board 72, gate line drive circuits 814C and 814D, a signal line drive circuit 815B, and a light-emitting element control circuit (DDIC) 74.

The point light sources 71 are arranged in a matrix having a row-column configuration in an area of the light source board 72 overlapping the detection area AA. The light source board 72 is a drive circuit board that drives each of the point light sources 71 so as to switch the state of the point light source 71 between on (lit state) and off (unlit state).

The light-emitting element control circuit 74 supplies control signals Sd, Se, and Sf to the gate line drive circuits 814C and 814D, and the signal line drive circuit 815B, respectively, to control operations of these circuits.

The host IC 75 includes, as a control circuit for the optical sensor 81, a sensor value storage circuit 751, a sensor value calculation circuit 752, a light intensity setting circuit 753, and a target value storage circuit 759. The sensor value storage circuit 751 stores therein the sensor values So output from the detection control circuit 816 of the optical sensor 81. The sensor value calculation circuit 752 performs a predetermined calculation process on the sensor values So of the photodiodes 813.

In a light intensity setting mode, the light intensity setting circuit 753 compares the sensor values So detected by the photodiodes 813 with a preset target sensor value So-t acquired from the target value storage circuit 759 to set light intensities of the point light sources 71 for detection. The target value storage circuit 759 stores therein the preset target sensor value So-t.

The host IC 75 includes, as a control circuit for the light source device 7, a lighting pattern generation circuit 754 and a lighting pattern storage circuit 755. The lighting pattern storage circuit 755 stores therein information on the light intensity of each of the point light sources 71 in the light intensity setting mode.

The lighting pattern generation circuit 754 generates various control signals based on the information on the light intensity in the lighting pattern storage circuit 755.

The host IC 75 further includes an image generation circuit 756. In a detection mode, the image generation circuit 756 generates an image of the objects to be detected 114, based on the sensor values So output from the photodiodes 813.

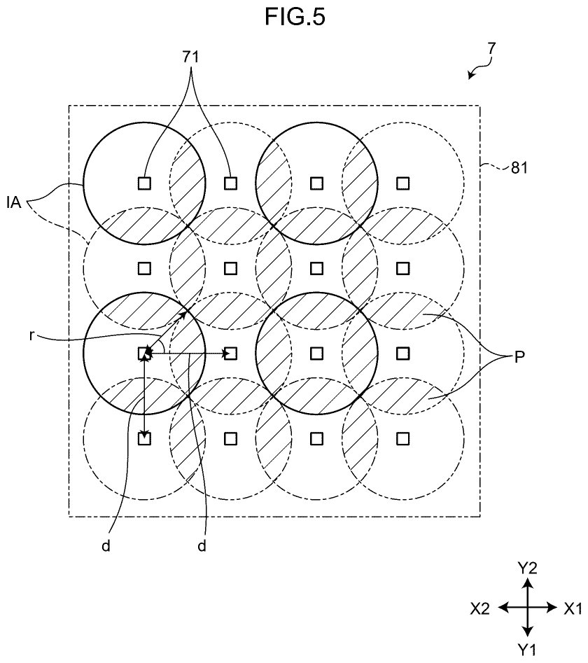

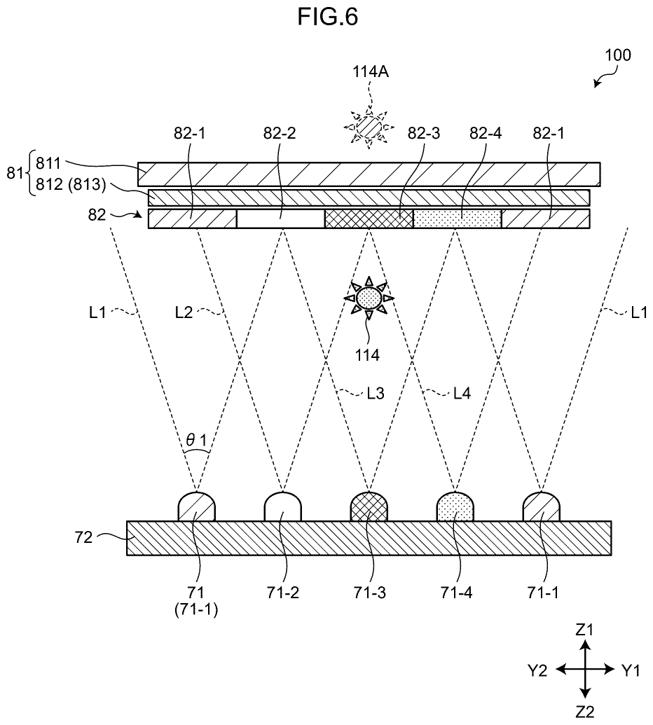

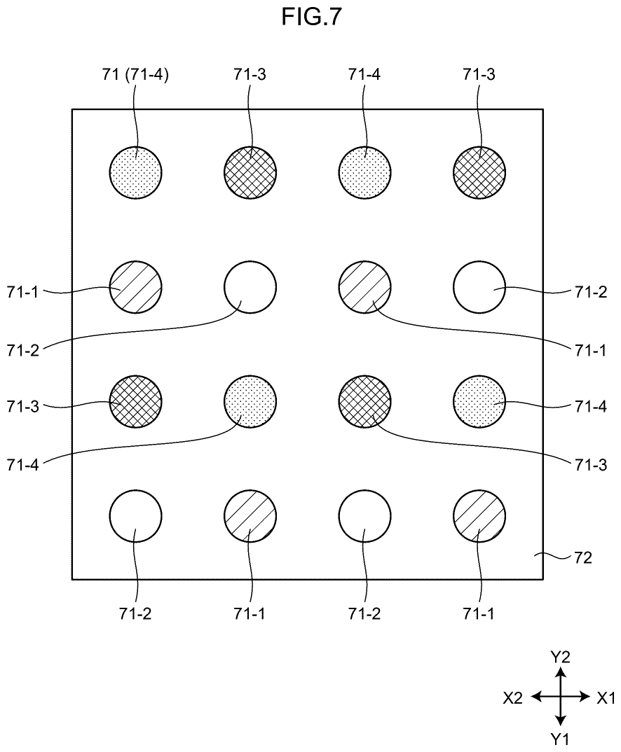

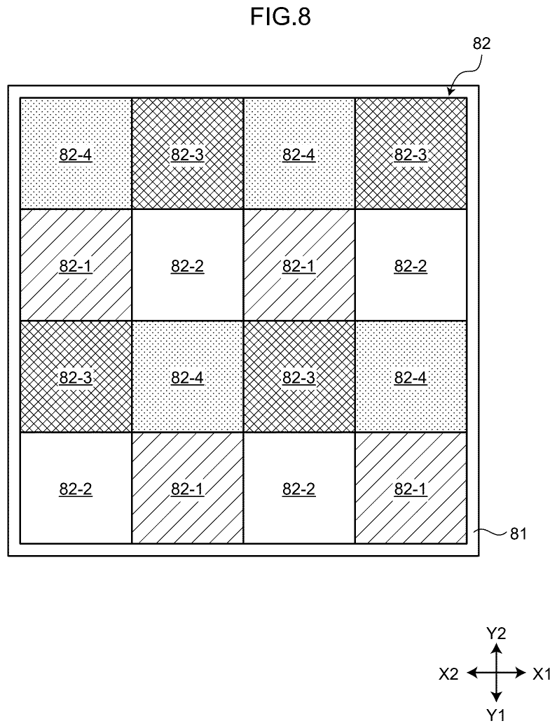

FIG. 5 is a schematic view illustrating projection areas of the emitted light from the point light sources. FIG. 6 is a schematic view of the detection device according to the first embodiment. FIG. 5 illustrates the projection areas of the light without the optical filter 82 according to the present embodiment. FIG. 7 is a schematic plan view of the light source device according to the first embodiment. FIG. 8 is a schematic plan view of the optical filter according to the first embodiment.

As illustrated in FIG. 5, a total of 16 point light sources 71 according to the present embodiment are provided. The 16 point light sources 71 are arranged at even intervals in the X and Y directions. Among these 16 point light sources 71, the distance between the point light sources 71 adjacent in the X direction is a distance d, and the distance between the point light sources 71 adjacent in the Y direction is also the distance d.

As illustrated in FIG. 6, the emitted light from each of the point light sources 71 radially spreads as it travels upward (toward the Z1 side). As a result, a projection area IA of light projected onto the optical sensor 81 without the optical filter 82 forms a circle of a radius r centered on the point light source 71, as illustrated in FIG. 5. The projection areas IA adjacent in the X or Y direction have an overlapping portion P indicated by hatching. This overlapping portion P makes the image of the object to be detected 114 blurry or hazy.

The following describes the point light sources 71 and the divided areas of the optical filter 82. As illustrated in FIG. 7, the total of 16 point light sources 71 according to the present embodiment are provided. The 16 point light sources 71 are arranged at even intervals in the X and Y directions. Specifically, four rows extending along the X direction are arranged and four columns extending along the Y direction are arranged. As for the rows, for example, in the first row, point light sources 71-4, 71-3, 71-4, and 71-3 are arranged from an X2 side toward an X1 side. In the second row, point light sources 71-1, 71-2, 71-1, and 71-2 are arranged from the X2 side toward the X1 side. In the third row, the point light sources 71-3, 71-4, 71-3, and 71-4 are arranged from the X2 side toward the X1 side. In the fourth row, the point light sources 71-2, 71-1, 71-2, and 71-1 are arranged from the X2 side toward the X1 side. As for the columns, for example, in the first column, the point light sources 71-4, 71-1, 71-3, and 71-2 are arranged from a Y2 side toward a Y1 side.

As illustrated in FIG. 8, the optical filter 82 according to the present embodiment is divided into a total of 16 pieces in plan view. That is, the optical filter 82 is divided in the X direction (second direction) and the Y direction (second direction) to have the 16 divided areas. The divided areas (divided areas 82-1 to 82-4) have a square shape in plan view and are evenly spaced in the X and Y directions. The 16 divided areas are arranged at even intervals in a grid pattern in the X and Y directions. Specifically, four rows extending along the X direction are arranged and four columns extending along the Y direction are arranged. For example, in the first row, the divided areas 82-4, 82-3, 82-4, and 82-3 are arranged from the X2 side toward the X1 side. In the second row, the divided areas 82-1, 82-2, 82-1, and 82-2 are arranged from the X2 side toward the X1 side. In the third row, the divided areas 82-3, 82-4, 82-3, and 82-4 are arranged from the X2 side toward the X1 side. In the fourth row, the divided areas 82-2, 82-1, 82-2, and 82-1 are arranged from the X2 side toward the X1 side.

In the present disclosure, the divided areas are not limited to the square in plan view. Thus, the divided areas may be, for example, equilateral triangles, or polygons having five or more vertices, in plan view.

As is clear from comparison between FIGS. 7 and 8, each of the divided areas overlaps a corresponding one of the point light sources 71 as viewed from the Z direction. For example, in the second row of the point light sources 71, the point light source 71-1 (first point light source), the point light source 71-2 (second point light source), the point light source 71-1, and the point light source 71-2 are arranged from the X2 side toward the X1 side, and in the second row of the divided areas of the optical filters 82, the divided area 82-1 (first divided area), the divided area 82-2 (second divided area), the divided area 82-1, and the divided area 82-2 are arranged from the X2 side toward the X1 side. Therefore, as viewed from the Z direction, the point light source 71-1 (first point light source) overlaps the divided area 82-1 (first divided area), and the point light source 71-2 (second point light source) overlaps the divided area 82-2 (second divided area). The point light source 71-1 (first point light source) is adjacent to the point light source 71-2 (second point light source) in the X direction, and the divided area 82-1 (first divided area) is adjacent to the divided area 82-2 (second divided area) in the X direction.

Also, in FIG. 6, as viewed from the Z direction, the point light source 71-1 overlaps the divided area 82-1, and the point light source 71-2 overlaps the divided area 82-2; and the point light source 71-3 overlaps the divided area 82-3, and the point light source 71-4 overlaps the divided area 82-4. Light L1 emitted from the point light source 71-1 irradiates the entire area of the divided area 82-1 and a portion of the divided area 82-2. In the same way, light L2 emitted from the point light source 71-2 irradiates the entire area of the divided area 82-2, a portion of the divided area 82-1, and a portion of the divided area 82-3. Light L3 emitted from the point light source 71-3 irradiates the entire area of the divided area 82-3, a portion of the divided area 82-2, and a portion of the divided area 82-4. Light L4 emitted from the point light source 71-4 irradiates the entire area of the divided area 82-4, a portion of the divided area 82-3, and a portion of the divided area 82-1. The irradiation angle of the light emitted from the point light source 71 is an angle θ1, and 114A represents a captured image of the object to be detected.

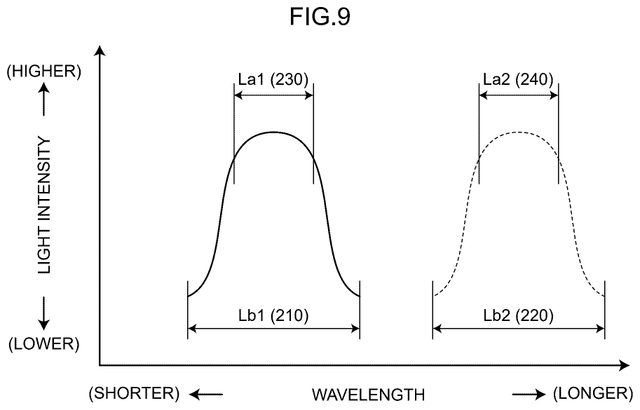

The following describes wavebands of the emitted light and transmitted light. FIG. 9 is a schematic diagram illustrating the wavebands of the emitted light and the transmitted light. In FIG. 9, a solid line indicates emitted light 210 from the point light source 71-1 (first point light source) and transmitted light 230 transmitted through the divided area 82-1 (first divided area). A dashed line indicates emitted light 220 from the point light source 71-2 (second point light source) and transmitted light 240 transmitted through the divided area 82-2 (second divided area).

The emitted light 210 has a first emitted light waveband Lb1, and the transmitted light 230 has a first transmitted light waveband La1. The first emitted light waveband Lb1 overlaps the first transmitted light waveband La1. The emitted light 220 has a second emitted light waveband Lb2, and the transmitted light 240 has a second transmitted light waveband La2. The second emitted light waveband Lb2 overlaps the second transmitted light waveband La2.

The first emitted light waveband Lb1 does not overlap the second emitted light waveband Lb2. The first transmitted light waveband La1 does not overlap the second transmitted light waveband La2.

Although not illustrated in the figure, the emitted light emitted from the point light sources 71 may have four or more different wavebands, and the transmitted light transmitted through the divided areas of the optical filter 82 may have four or more different wavebands.

For example, the waveband of the emitted light may have a first waveband having a waveband of 460 nm to 500 nm, a second waveband having a waveband of 500 nm to 570 nm, a third waveband having a waveband of 570 nm to 590 nm, and a fourth waveband having a waveband of 610 nm to 780 nm. For example, the first waveband corresponds to blue, the second waveband to green, the third waveband to yellow, and the fourth waveband to red. However, the yellow is not reproduced by mixing red and green, but is produced by a single light source.

As described above, the detection device 100 includes the light source device 7 including the point light sources 71, the light-transmitting placement substrate 111 on which the object to be detected 114 is placed, the optical filter 82 having a plurality of divided areas, and the optical sensor 81 including the photodiodes (photodetection elements) 813. The first point light source 71-1 overlaps the first divided area 82-1 of the optical filter 82 as viewed from the Z direction. The first emitted light waveband Lb1 of the emitted light 210 emitted from the first point light source 71-1 overlaps the first transmitted light waveband La1 of the transmitted light 230 transmitted through the first divided area 82-1.

As described above, when the multiple point light sources 71 are arranged, the single object to be detected 114 is irradiated with light rays in different directions from the multiple point light sources 71, potentially resulting in blurring of the image captured by the optical sensor 81. That is, light having multiple wavebands is incident on a certain area of the optical sensor 81.

In contrast, in the present disclosure, the first divided area 82-1 of the optical filter 82 and the first point light source 71-1 are arranged in the Z direction so as to overlap each other, and the first emitted light waveband Lb1 overlaps the first transmitted light waveband La1. Therefore, the light transmitted through the first divided area 82-1 of the optical filter 82 is limited to the emitted light 210 emitted from the first point light source 71-1, thereby inhibiting the light having multiple wavebands from entering a certain area of the optical sensor 81. As a result, the blurring of the image captured by the optical sensor 81 can decrease.

The second point light source 71-2 is adjacent to the first point light source 71-1 in the second direction, and the second divided area 82-2 of the optical filter 82 is adjacent to the first divided area 82-1 in the second direction. The second point light source 71-2 overlaps the second divided area 82-2 as viewed from the Z direction. The second emitted light waveband Lb2 of the emitted light 220 emitted from the second point light source 71-2 overlaps the second transmitted light waveband La2 of the transmitted light 240 transmitted through the second divided area 82-2. The first emitted light waveband Lb1 does not overlap the second emitted light waveband Lb2, and the first transmitted light waveband La1 does not overlap the second transmitted light waveband La2.

That is, the wavebands of the light rays transmitted through the divided areas adjacent in the second direction in the optical filter 82 do not overlap each other.

Therefore, compared with the conventional aspect in which the wavebands of the light rays transmitted through the divided areas adjacent in the second direction in the optical filter overlap each other, the present embodiment further inhibits the light rays having multiple wavebands from entering a certain area of the optical sensor 81. As a result, the blurring of the image captured by the optical sensor 81 can further decrease.

The divided areas are arranged in a grid pattern as viewed from the Z direction. This configuration can reduce the number of boundaries between the adjacent divided areas and also reduce the blurring of the image captured by the optical sensor 81.

### Second Embodiment

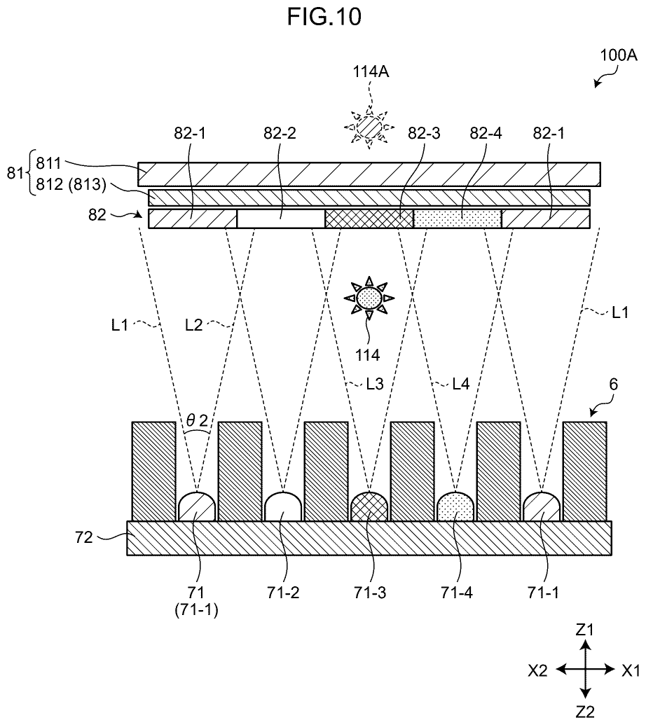

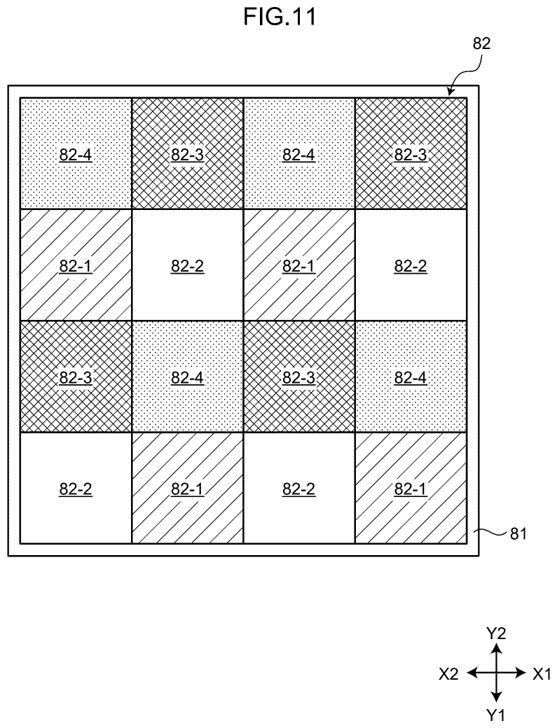

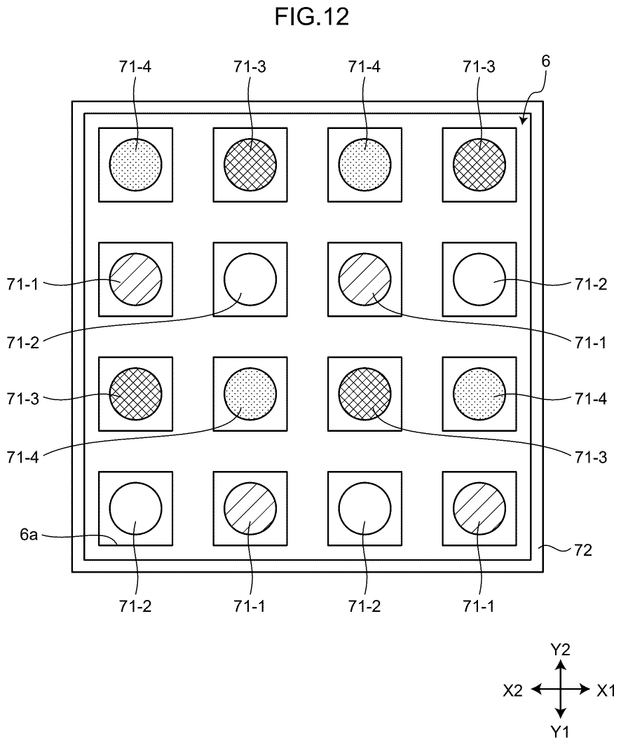

The following describes a second embodiment of the present disclosure. FIG. 10 is a schematic view illustrating a detection device according to the second embodiment. FIG. 11 is a schematic plan view of the optical filter according to the second embodiment. FIG. 12 is a schematic plan view of the light source device according to the second embodiment.

A detection device 100A according to the second embodiment differs from the detection device 100 according to the first embodiment in including a side wall 6. The following specifically describes the side wall 6.

As illustrated in FIGS. 10 and 12, the side walls 6 separate the point light sources 71 from one another. That is, the side wall 6 is a separating wall between the point light sources adjacent in the X direction and between the point light sources adjacent in the Y direction. The side wall 6 has a grid shape as viewed from the Z direction. The side wall 6 protrudes toward the Z1 side. The side wall 6 is larger in height than the point light sources 71. The side wall 6 has visible light absorbability to absorb at least part of visible light. As illustrated in FIG. 10, the irradiation angle of the light emitted from the point light source 71 is an angle θ2. The angle θ2 is smaller than the angle θ1 (refer to FIG. 6).

As described above, the detection device 100A includes the side wall 6 that separates the point light sources 71 from one another. The side wall 6 has visible light absorbability to absorb at least part of visible light.

The irradiation angle of the light emitted from the point light source 71 is the angle θ2, and the angle θ2 is smaller than the angle θ1 (refer to FIG. 6). That is, the side wall 6 limits part of the light emitted from the point light sources 71 toward the Z1 side, resulting in a smaller irradiation angle of the light. Since the side wall 6 has visible light absorbability, the intensity of reflected light is smaller than in a case of a normal louver. From the above, the light irradiating the divided areas of the optical filter 82 can be more concentrated.

What is claimed is:

1. A detection device comprising:
a light source device comprising a plurality of point light sources arranged in a planar configuration;
a light-transmitting placement substrate that is located so as to overlap one side in a first direction of the light source device, and on which an object to be detected is placed;
an optical filter that is located so as to overlap one side in the first direction of the placement substrate and has a plurality of divided areas divided in a second direction intersecting the first direction;
an optical sensor that is located so as to overlap one side in the first direction of the optical filter and comprises a plurality of photodetection elements arranged in a planar configuration, wherein
a first point light source of the point light sources overlaps a first divided area of the divided areas of the optical filter as viewed from the first direction, and
a first emitted light waveband of emitted light emitted from the first point light source overlaps a first transmitted light waveband of transmitted light transmitted through the first divided area.

2. The detection device according to claim 1, wherein
a second point light source of the point light sources is adjacent to the first point light source in the second direction,
a second divided area of the divided areas of the optical filter is adjacent to the first divided area in the second direction,
the second point light source overlaps the second divided area as viewed from the first direction,
a second emitted light waveband of emitted light emitted from the second point light source overlaps a second transmitted light waveband of transmitted light transmitted through the second divided area,
the first emitted light waveband does not overlap the second emitted light waveband, and
the first transmitted light waveband does not overlap the second transmitted light waveband.

3. The detection device according to claim 2, wherein
the light source device comprises a side wall that extends in the first direction and separates the point light sources from one another, and
the side wall has visible light absorbability to absorb at least part of visible light.

4. The detection device according to claim 2, wherein
the divided areas are arranged in a grid pattern as viewed from the first direction,
the emitted light emitted from the point light sources has four or more different wavebands, and
the transmitted light transmitted through the divided areas of the optical filter has four or more different wavebands.

5. The detection device according to claim 3, wherein
the divided areas are arranged in a grid pattern as viewed from the first direction,
the emitted light emitted from the point light sources has four or more different wavebands, and
the transmitted light transmitted through the divided areas of the optical filter has four or more different wavebands.
